(19) United States
(12) Patent Application Publication
(10) Pub. No.: US 2012/0114488 A1
(43) Pub. Date: May 10, 2012

(54) WIND POWER PLANT, TRANSMISSION FOR A WIND POWER PLANT AND FLEXPIN

(76) Inventor: Urs Giger, Muhlau (CH)

(21) Appl. No.: 13/322,352

(22) PCT Filed: May 20, 2009
(86) PCT No.: PCT/EP09/03609

§ 371 Date: Nov. 23, 2011

(30) Foreign Application Priority Data
May 20, 2008 (DE) 10-2008-024-351.5

(51) Int. Cl. F03D 11/02; F03D 11/00

(52) U.S. Cl. 416/170 R

(57) ABSTRACT

According to prior art, a transmission of a wind power plant is integrated at least partially into a hollow main shaft. In terms of said type of conception, a shoulder stop is provided to limit deformation of the main shaft. Also, a planetary gear of a wind power plant transmission is placed on a sleeve of a flexpin. In this respect, an intermediate sleeve, in particular designed as a friction bearing is provided. Also known is that the main shaft is placed with a pretensioned rolling bearing in the housing of the wind power plant. In this respect, a hydrostatic friction bearing is used instead. The above-mentioned aspects of the invention enable the service life of the wind power plant to be significantly increased whilst at the same time simplifying maintenance and reducing production and maintenance costs as well as lowering noise emissions.

The invention relates to a wind power plant, particularly a wind power plant with an integrated transmission, a transmission for a wind power plant, particularly a gear stage for a multi-stage transmission as well as a flexpin for the transmission of a wind power plant.

A wind power plant converts the kinetic energy of the wind into electric energy and feeds it into the power network. This is done in that the movement energy of the wind flow acts on the rotor blades. These are mounted in the hub so that the entire rotor with hub is put into a rotary motion. The hub is connected to a transmission via a shaft. In most cases this is a planetary gear set. The rotation is subsequently passed on to a generator which produces the electric power.

US 2006/0104815 A1 shows the head of a wind power plant with a hub, which at the transition to the shaft is mounted so that the transverse forces are absorbed there. From the hub to the generator a relatively thin shaft can therefore be used which merely has to be torsion-resistant. This is correspondingly cost-effective.

EP 1 788 281 A1 shows a transmission for a wind power plant.

EP 0 792 415 B2 shows a planetary gear set for a wind power plant with a planet carrier mounted in a transmission housing, which is connected to a driveshaft subjected to transverse force load. The driveshaft is mounted in the transmission via the planet carrier.

EP 1 482 210 B1 proposes a transmission with a power-adding stage which comprises two planetary gear sets, each having a sun, planet gears, an internal gear and a common planet carrier.

The patent proprietor has likewise proposed to integrate a coupling transmission into the rotor hub. With the transmission integrated in the rotor hub and the mounting in only one rotor main bearing a significant increase of the power density can be achieved.

EP 1 544 504 A2 describes a tapered roller bearing for a wind power plant.

WO 2008/104257 A1 to PCT/EP 2008/000658 (day of application Jan. 29, 2008 at the European Patent Office as receiving authority for the PCT application), which originates from the same inventor and applicant and which by way of the referencing is likewise included in the disclosure content of the patent application present here, shows a wind power plant with a transmission, wherein the transmission at least in part is arranged within a main shaft of hollow design.

The invention is based on the object of making available an improved power plant.

According to a first aspect of the invention this object is solved by a wind power plant with a transmission, wherein a torque is transmitted from a hub via a main shaft to the transmission, and wherein the transmission at least in part is arranged within a hollow space in the main shaft, wherein a shoulder stop for limiting a deformation of the main shaft at least with respect to its longitudinal axis, i.e. perpendicularly to its longitudinal axis, is provided.

In terms of definition the following is explained in this regard:

The “main shaft” is designed according to the prior art of the referenced pre-application at least in part as hollow shaft, so that the transmission at least in part can be arranged within the hollow main shaft. Depending on the concrete design, this brings numerous advantageous within reach: in particular, it makes possible a very short design of the head of the wind power plant.

During investigations of the inventor it has transpired however that the wear within the transmission with such a transmission design can be extraordinarily reduced if the “shoulder stop” for the main shaft is provided. Through the hollow design of the main shaft, said main shaft can accept relatively large deformations with unfavourable force input. This subjects the gears or the other parts of the transmission to relatively strong loads under certain conditions. However, as soon as a shoulder stop is provided, the main shaft comes to bear against this shoulder stop in the event of an excessively large deflection. This limits the deformations to be expected and contributes to an increased lifespan of the wind power plant.

Alternatively and cumulatively to the first introduced aspect of the invention, the set object is solved by a wind power plant with a transmission, wherein a torque is transmitted from a hub via a main shaft to the transmission, and wherein the wind power plant comprises a rotating transmission housing, wherein a shoulder stop for limiting a deformation of the rotating transmission housing with respect to its axis of rotation is provided.

It is to be understood that even with such a design the transmission is adequately protected from excessive deflections, which likewise results in an increase of the lifespan of the wind power plant.

In particular the wind power plant can be designed so that the hollow shafts and the rotating transmission housing are one and the same component.

The invention aspects introduced here are of interest particularly with wind power plants with a rated power of 1.5 MW, 2.5 MW, 3 MW, 5 MW or more, since the transmissions of such plants as a rule have a diameter of more than 2 m. The plants are thus very large and require correspondingly much material. The possible materials must be of a high quality since large torques and forces have to be transferred. The heads of such wind power plants are therefore normally constructed very large. With prototype calculations of the inventor regarding the referenced pre-application, shortening of 1,000 mm and more have resulted. Thus, estimated mass savings of for example 10 t can be achieved. It must therefore be assumed that the type of design of the pre-application referenced here will be increasingly employed because of the massive cost reduction.

The invention is particularly effective then, when the main shaft has a cup shape.

With regard to definition and content it is explained initially that only the “main shaft” was discussed here. However, it is to be understood that the same technical advantage can be achieved when the “rotating transmission housing” has a cup shape. It has already been explained above that with suitable design the “main shaft” and the “rotating transmission housing” can be one and the same component. In the following, whenever possible, only the “main shaft” is therefore discussed, wherein the aspects then described are in each case identically applicable also to a suitably designed “rotating transmission housing”.

If the main shaft has a cup shape so that it rotates about an axis of rotation of the cup when the wind power plant is in operation, the bottom of the cup because of its disc shape is then relatively sturdy with respect to deflections regarding the axis of rotation. This is true in particular when the bottom of the cup in fact comprises a solid disc. Such a disc can for example be provided where the main shaft is flanged onto the hub. The effect of the relatively high stiffness against deformations perpendicular to the axis of rotation occurs even then, when only a part of a disc is embodied, i.e. when for example a disc ring is present on that side of the main shaft which is used for connection to the hub.

A hollow shaft for receiving the transmission in a wind power plant is generally designed so that the open side of the cup opposite the bottom of the cup can generate substantially less resistance regarding a deformation perpendicularly to the axis of rotation. The present invention has recognised that this altogether can lead to a sometimes substantial deformation of the cup shape. This is where the shoulder stop helps.

It is proposed that the shoulder stop is provided on an open edge of the main shaft.

When the main shaft has a cup shape the shoulder stop would be arranged on the open edge of the cup.

In any case it is recognisable that especially an open edge of the main shaft is particularly susceptible to deformations, so that in this case the shoulder stop can counteract in a highly effective manner.

It is of particular advantage when the shoulder stop is provided on an access side of the main shaft. A hollow shaft in the dimension of wind power plants is suitable as a rule that construction or maintenance personnel can enter the shaft from an “access side”. With suitable design, the transmission components which are arranged within the hollow shaft can be pulled out on the access side of the main shaft for maintenance.

In order to design both the entry opening as well as the possible passage for transmission components as large as possible it is practical if the main shaft on the access side is opened as far as possible. However, this is accompanied by a weakening of the deformation resistance so that it is practical in turn to provide the shoulder stop exactly at this point or at least in the near region.

With respect to design, the shoulder stop can limit deformations quite simply if it is at least in part arranged within the main shaft.

This can be realised particularly easily if the shoulder stop protrudes into the main shaft in the manner of a cantilever. Above all, the shoulder stop can stand away from a solid component and protrude into the main shaft through the access side or the open edge of the main shaft in the manner of a cantilever, at least into the edge of the main shaft.

If the shoulder stop protrudes into the main shaft in the manner of a cantilever, a deformation of the main shaft is opposed by a limitation from the inside as soon as the inside of the main shaft reaches the shoulder stop.

Alternatively it is conceivable to arrange the shoulder stop outside the main shaft. However, an arrangement within the main shaft once again results in a compact design.

In order to impart to the shoulder stop as great a stiffness regarding deflections from the axis of rotation as possible, it can be preferably fastened to a disc which stands perpendicularly to an axis of rotation of the main shaft.

Alternatively and cumulatively it is conceivable that the shoulder stop is connected to a bearing for the main shaft via a disc. It must be assumed that the bearing for the main shaft with most wind power plants constitutes one of the sturdiest components.

In order to increase the resistance of the main shaft to deformations it is provided that the main shaft at an open end comprises a stiffening disc ring which stands perpendicularly to an axis of rotation of the main shaft.

If the shoulder stop is arranged between the main shaft and a planet carrier device, to a particular degree the deformation of the main shaft is limited just like a possible deflection of the flexpin due to extreme loads.

Depending on concrete design, the shoulder stop can otherwise also be arranged such that the flexpin or otherwise designed planet carriers initially strike the shoulder stop. In this manner it is also possible to limit the deformation as a whole. With an arrangement of the shoulder stop between an open edge and the planet carriers a rapid deformation limitation is ensured in any deflection direction whatsoever.

According to the previous findings of the inventor it is preferred, however, if a play spacing between the shoulder stop and the open edge of the main shaft is smaller than the play spacing between the shoulder stop and the planet carrier device. The reason for this must be seen in that upon a part of the wind power plant striking the shoulder stop as a result of an extreme load a local deformation forcibly occurs at the stop point, even if mostly of an elastic type. Thus, when the contact between the main shaft-transmission construction against the shoulder stop occurs via the planet carrier device, a deformation is directly introduced into the planet carrier device. Compared with this it is mostly an advantage if the deformation is merely introduced locally at the free edge of the main shaft, while the planet carrier device is held as much as possible free of deformation and forces.

It is proposed that the shoulder stop in an unloaded state has a spacing of less than 10 cm to the main shaft, preferably of less than 1 cm, preferentially of less than 1 mm, and most preferably no spacing at all, but a friction bearing with corresponding play. The spacing to the main shaft is to be interpreted radially with regard to the axis of rotation of the main shaft, because this is the main deformation direction.

In a particularly preferred design the shoulder stop forms a bearing for the free edge of the main shaft, particularly for a one-piece stiffening annular disc preferentially provided there. In particular, a hydrodynamic bearing is considered and/or a friction bearing of another type. Because of this, the deformation of the main shaft can be limited further still.

In a particularly preferred embodiment the bearing is arranged between the shoulder stop and the open edge of the main shaft so that the direction of the bearing force on the main bearing, at least of a cone bearing ring of the main bearing runs through the shoulder stop.

During prototype investigations of the inventor it has been shown that through a structural over determination at the open end of the main shaft the deformations could be massively reduced through hyperstatic dimensioning at the open end of the main shaft. Thus, values according to which the deformations could be reduced for example from 41 mm to only 6 mm where obtained during measurements.

It is to be understood that a transmission for a wind power plant, which is designed so that a shoulder stop can intervene or a shoulder stop is even included, directly profits from the advantages stated above, likewise the entire wind power plant.

According to a third aspect of the invention the set object is solved by a flexpin for a wind power plant, particularly for a wind power plant as described above, wherein the flexpin comprises a pin and a sleeve mounted on the pin, wherein the sleeve is equipped for carrying a planet and wherein the flexpin, that is in this case the sleeve, comprises an intermediate bush for carrying the planet.

The following is first explained with regard to definition:

With a flexpin a sleeve sits on a central pin which is flanged to a disc. Said sleeve is generally mounted quite far on the protruding face end of the pin and has a deformation play towards the inside, i.e. towards the pin. On the side directed to the flange disc it is mostly flared so that it can freely slide there.

The advantage of a flexpin design lies in that a deflection results in an S-shaped deformation of the pin while the sleeve is substantially displaced in parallel. This keeps the tilting of teeth of the planet seated on the flexpin within small limits.

In most cases, the pin is secured to the back of the disc with a locking ring. A second locking ring in most cases is seated on the free face end of the pin for securing the sleeve.

Here it is now proposed that an intermediate bush is provided. In the ideal case, this is arranged radially outside on the sleeve so that the planet is no longer directly carried by the sleeve, but rather by the intermediate bush.

It is advantages here that the intermediate bush with regard to the mounting of the planet can be designed entirely independently of the sleeve of the flexpin.

Thus it is conceivable for example that the intermediate bush is designed as friction bearing bush. A friction bearing in this position, if suitably designed, can already result in that the planets are mounted in a very low noise manner. Especially with a view to wind power plants being built ever closer to existing residential areas this can result in decisive advantages compared with previous wind power plants.

It is proposed in particular that the intermediate bush comprises bronze on a sliding surface.

If the intermediate bush is otherwise free of radial protrusion on a side facing away from the pin end it can, if suitably designed, be axially pulled off via the free pin end. Thus, it can be replaced relatively easily. Especially when the intermediate bush forms or comprises a slide bearing, this can be of special interest. The maintenance personnel then merely has to pull the intermediate bush off the sleeve of the flexpin and slide in a new intermediate bush.

While doing so, the planet can otherwise remain in position for the planet is in mesh between the internal gear and the sun when the turbine is stationary. The intermediate bush can, with suitable design without obstructing protrusion, be therefore pulled off without having to pull off the planet.

It is to be understood that the planet should nevertheless be designed so that it can also be pulled of axially.

It is proposed that the intermediate bush comprises a disc-shaped axial bearing ring, particularly towards a free end of the pin, above all connected to the intermediate bush or unitarily formed with the latter.

Such an axial bearing ring can even be used for axially securing the planet. To this end, the axial bearing ring can be unitarily moulded with the intermediate bush or for example be screwed to the latter. The nature of such an axial bearing ring for the planet is substantially that the ring radially reaches further to the outside than the intermediate bush so that a planet located radially outside arranged on the intermediate bush cannot be axially moved off the intermediate bush for as long as the axial bearing ring is there.

The axial bearing ring can be arranged on one or on both sides of the planet.

It is proposed that an axial bearing ring comprises a sliding surface for the sliding of the planet and/or the intermediate bush, particularly by means of a bronze ring.

The intermediate bush is preferably mirror-symmetrical perpendicularly to the pin with respect to a mirror plane. This already facilitates the maintenance of the wind power plant.

If the intermediate bush has a radial oil transport bore and if the sleeve of the flexpin preferably has a radial oil transport bore in addition, oil can be pressed into the play free space present between the pin and the sleeve anyway. This oil can migrate along the pin through the ring gap towards the front until it can exit through the oil transport bore through the sleeve to the outside and in this manner reach the intermediate bush.

In the intermediate bush an oil feed pocket is preferably provided. This should be orientated towards the pin. Thus initially towards the sleeve, particularly to the oil transport bore through the sleeve.

Through an oil transport bore the oil can reach the planet through the intermediate bush.

On the side of the intermediate bush orientated away from the pin and thus radially from the inside towards the planet an oil bearing pocket is preferably provided, that is a bearing pocket preferably reaching about the entire circumference of the intermediate bush for the accumulation of oil with high pressure, so that the oil can form a securely carrying sliding film for the planet on the intermediate bush.

Preferably, the intermediate bush is mounted on the sleeve with a loose seat. This facilitates the replaceability.

In the ideal case, a replaceable friction bearing is thus created through the intermediate bush on the sleeve of the flexpin which is noise-optimised, efficiency-optimised and procurement-optimised.

It is to be understood that the advantages of the flexpin described above can also bring direct advantages for a transmission of a wind power plant and the entire wind power plant especially when in the transmission or in the entire wind power plant the planet is mounted on the intermediate bush with a loose seat.

According to a fourth aspect of the invention the said object is solved by a wind power plant particularly designed as described above with a housing and a main shaft mounted therein, wherein the main shaft and the housing comprise a hydrostatic bearing against each other.

With conventional wind energy plants the main shaft is mounted with a pre-tensioned rolling bearing. Rolling cones however are not only extraordinarily expensive but also difficult to procure. A hydrostatic friction bearing as alternative for the main bearing to the rolling bearing is thus in turn not only noise-optimised, but additionally efficiency-optimised and procurement-optimised.

In addition, a longer lifecycle of a friction bearing must be assumed, for a rolling bearing according to the prior art requires a pre-tension. When wear occurs at this point at the latest, the pre-tension frequently results in unforeseeable damages after a certain time.

Preferably, the bearing comprises two bearing rings. Each by itself should form a complete bearing point in circumferential direction.

Between the two bearing rings a collar radially protruding from the main shaft can be provided. In this manner, an arrangement of the sequence bearing ring—protruding collar—bearing ring is created when viewed axially. This is adequate for an axial mounting of the main shaft. Merely the bearing rings have to be fastened to the housing, for example via screwed-on fastening flanges and additional components are not required for axially mounting the main shaft.

Between the bearing rings and the collar axial bearing pockets for oil are preferably provided. Upon every load introduction into the axial bearing of bearing ring-collar-bearing ring an adequate safeguarding of the metallic materials has to be guaranteed. This can be particularly easily achieved in that at the potential contact points, that is the potential radially standing disc rings, oil bearing pockets are provided. It has already been mentioned that the axial bearing rings are preferably releasably fixed on the housing so that they can be easily replaced.

It is particularly advantageous if the bearing comprises a segmented bearing ring. In particular, each bearing ring can be of the two-piece type in circumference. With such a design, each bearing ring can also be removed substantially radially, i.e. does not have to be axially pulled out or pushed on in its entire size.

In a preferred embodiment of the wind power plant an oil pump for introducing oil as bearing fluid in bearing pockets, particularly with a pressure of more than 50 bar, preferably with a pressure of over 80 bar, more preferably with a pressure of approximately 100 bar. A high-pressure pump of this type can generate a lot of pressure with little throughput, so that despite a secure mounting little oil is consumed or at least squandered in the interior space.

In order to guard against the danger that the bearing pressure collapses and the oil leaks out when the shaft is displaced it is proposed that a pressure drop detection for the oil pressure is provided. The pressure drop detection is preferably designed so that it reduces or even stops the pump output, but preferably at least initially increases the pump output in order to hold the bearing pressure at least substantially constant when the oil pressure drops as a result of a shaft displacement.

According to a fifth aspect of the invention the set object is solved by a wind power plant with a transmission, wherein a torque is transmitted from a hub via a main shaft to the transmission, and wherein the main shaft is mounted against a housing, and wherein a controlled fluid damper is provided for the main shaft.

Rapid reaction to fluctuations of attacking forces is thus possible and the damping can be specifically increased there, where otherwise a deformation would be expected or where a deformation is detected,

If the main shaft is hydrostatically mounted the damping can be adjusted via the bearing fluid in a simple manner. The damping can be controlled in minutest fractions of a second since merely the pressure needs to be increased or reduced. Preferably, for this reason, an oil feed to the damper is therefore provided.

Preferably, the main shaft is mounted on a shoulder stop. There, damping forces can be generated in a particularly suitable manner.

If a sensor for a deformation is provided, it is possible to react to the respective deformation measured and a further excessive deformation in this direction counteracted.

Such a sensor can be provided on a stiffening disc.

It is proposed that the fluid damper comprises several fluid outlets which are arranged distributed over a circumference of the main shaft and which can be preferably activated individually. Then, specific reaction to any deflection direction is possible.

Preferably, with a controlled fluid damper, the transmission is arranged at least in part within a hollow space in the main shaft.

According to a sixth aspect of the invention the said object is solved by a wind power plant with a housing and a main shaft mounted therein, wherein the main shaft and the housing have a bearing against each other, particularly a pre-tensioned tapered roller bearing, wherein a unitary pre-tension adjusting unit is provided.

Such an adjusting unit can for example consist of a flange that can be screwed on and fixed via the screws, wherein the flange is located between the housing and a bearing point, for example between the housing and a bearing ring or a bearing cone carrier.

The invention is explained in more detail in the following by means of different exemplary embodiments. It shows

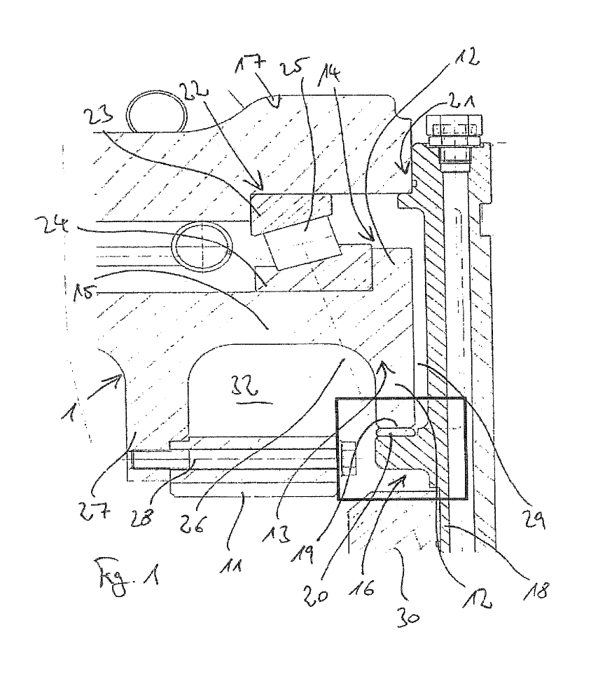

FIG. 1 schematically in a section an open edge of a hollow main shaft with a hydrodynamic bearing on a shoulder stop,

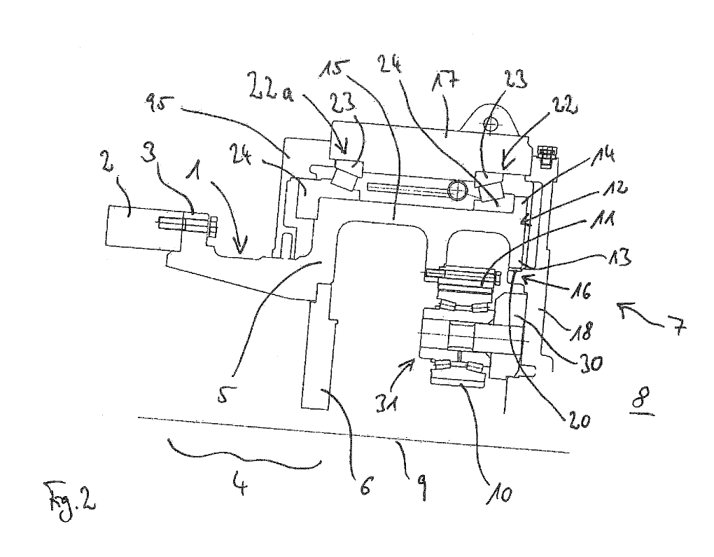

FIG. 2 in a perspective, partially sectioned view the construction from FIG. 1 in a possible application,

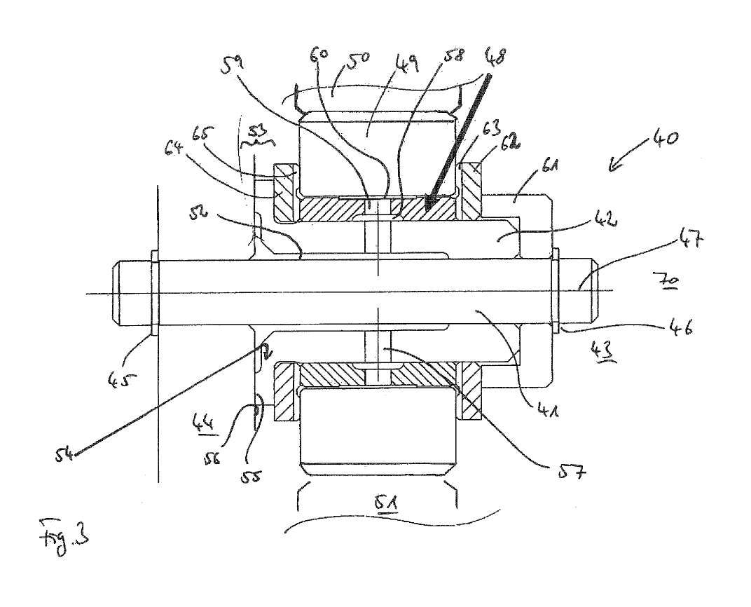

FIG. 3 schematically a section through a flexpin with an intermediate bush as friction bearing and

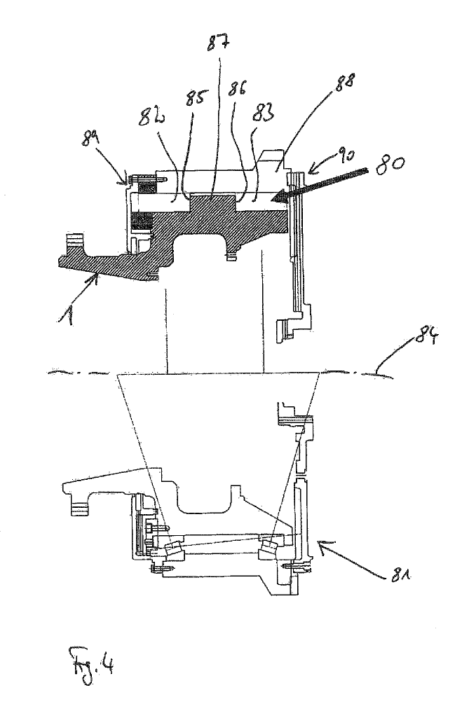

FIG. 4 schematically in a section a possible construction of a hydrostatic friction bearing for a main shaft.

The hollow main shaft 1 in the FIGS. 1 and 2 starts at a hub 2 of a wind power plant. It is flanged on for the transmission of rotary movements via a circumferential web 3.

The main shaft 1 substantially has a cup shape, since in a region 4 on the hub side it initially itself forms a cup bottom in an angled-off region 5. The cup bottom is again reinforced through a stiffening disc 6.

At an open end 7 however, that is in the direction of an access side 8, the main shaft 1 however is much weaker with respect to a possible deflection perpendicularly to an axis of rotation 9 of the main shaft 1, i.e. in radial respect. This can have a disadvantageous effect with conventional transmissions of wind power plants. Whenever extreme loads act on the rotor blades (not shown), for example in the case of an incoming gust during a storm, deformations of the components and displacement of the components relative to each other naturally occur. This can result in high pressures of planet teeth 10 (drawn exemplarily), an internal gear 11 and/or a sun (not shown).

To reduce this, a stiffening disc ring 12 is initially formed at the open end 7 of the main shaft 1. This stiffening disc ring protrudes with an inner region 13 towards the axis of rotation 9, with a region 14 located radially outside however to the outside away from a cylindrical jacket 15 of the main shaft 1.

In order to even further reduce the possible radial deformations of the open end 7 of the main shaft 1 a shoulder stop 16 is provided. This protrudes from a stiffening disc 18 connected to a housing 17 into the open end 7 of the main shaft in the manner of a cantilever and forms a movement limitation for the stiffening disc ring 12 of the main shaft 1 on a stop surface 19 on a friction bearing 20 located radially inside.

Through the stiffening disc 18 the shoulder stop 16 is already relatively well protected from radial deformations with respect to the axis of rotation 9. As a result of the screwing to connecting points 21 to the housing 17, this effect is improved further still.

The shoulder stop 16 is arranged so that it fixes the open end 7 of the main shaft 1 through a two-sided thrust mounting in a very favourable manner:

Thus, the main shaft 1 is mounted against the housing 17 on a tapered roller bearing 22 and on a second tapered roller bearing 22a. In order to be able to have the tapered roller bearings 22, 22a run with as little wear as possible and in order to fix the main shaft 1 in the housing 17, the main shaft 1 is subjected to pre-tension on the tapered roller bearings 22, 22a. Thus, a compressive force with a compressive force direction 26 develops via cone bearing rings 23, 24 and rolling cones 25 (drawn exemplarily).

The inner part 13 of the stiffening disc ring 12 is pulled towards the axis of rotation 9 of the main shaft 1 so far that the shoulder stop 16 counteracts a deflection going radially to the inside substantially in a direction continuation of the compressive force direction 26 with a bearing pressure force radially acting to the outside. Because of this, the main shaft 1 at its open end 7 merely moves very little in radial respect. Upon calculations on a prototype of the inventor a deformation of the main shaft 1 was reduced from 41 mm to 6 mm due to the hyperstatic dimensioning at the open end 7.

The reduced deformation at the open end 7 of the main shaft 1 results in that the internal gear 11 unitarily formed with the main shaft 1 via a support disc ring 27 and fixed via a screw 28 likewise accepts only very low radial deflections.

Since the tapered roller bearings 22, 22a are not only pre-tensioned in radial respect but also in axial respect, the axial bearing forces of the two tapered roller bearings 22, 22a normally compensate each other. In order to be able to guard against a possible deformation also here, an additional axial bearing for the open end 7 can be additionally provided between the stiffening disc 18 and the stiffening disc ring 12 of the main shaft 1, for example likewise in the form of a friction bearing.

The stiffening disc 18 otherwise preferably simultaneously serves for receiving a planet carrier 13 for a flexpin 31.

In the hollow space 32 of the rotating main shaft 1, which simultaneously constitutes a rotating transmission housing, not only a substantial part of the transmission but simultaneously also the shoulder stop 16 with the friction bearing 20 are located.

The transmission construction is thus very short, which directly allows a compact and thus cost-effective design of the entire wind power plant.

A pre-tension adjusting unit 95 is embodied unitarily.

The flexpin 40 in FIG. 3 substantially consists of a pin 41 and a sleeve 42, wherein the sleeve 42 at an open face end 43 of the pin 41 is mounted on said pin. The pin 41 at the back is fixed in a planet carrier 44. For example, this can be the stiffening disc 18 (see FIGS. 1 and 2) or the planet carrier 44 is fastened to the stiffening disc 18, like the planet carrier 30 there.

Two locking rings 45, 46 ensure axial securing.

With respect to an axis of rotation 47 radially outside on the sleeve 42 an intermediate bush 48 is provided. Only radially outside on said intermediate bush a planet 49 is mounted, wherein said planet with respect to an axis of rotation 9 (not shown here, see FIG. 2) meshes with its teeth with an internal gear 50 further to the outside and with respect to the axis of rotation 9 radially with a sun 51 further to the inside.

Within the sleeve 42 of the flexpin 40 a long axial ring slit 52 is arranged. At an opening 53 of the sleeve 42 this initially flares into an annular disc piece 54, subsequently with an axial continuation 55, this deforms as far as to a sliding surface 56 of the planet carrier 44.

At half the axial height of the planet 49 a radial oil transport bore 57 towards the hollow-cylindrically designed intermediate bush 48 is provided. The oil transport bore 57 leads into an oil feed pocket 58 in the intermediate bush 48. From there, a further oil transport bore 59 leads to an oil bearing pocket directly towards the planet 49.

Axially, between the locking ring 46 and the sleeve 42, a holding cup 61 is arranged. This reaches as far as to an axial friction bearing ring 67 with a friction bearing 63.

Axially on the other side of the planet 49 is located a second axial bearing ring 64 with a second axial friction bearing 65.

In operation of the wind power plant, the flexpin 40 ensures a compensation of peak loads during extreme loads. Upon a radial deflection the entire region arranged outside the planet carrier 44 is displaced, wherein the pin 41 assumes an S-shape, since the striking of the continuation 55 against the sliding surface 56 substantially ensures parallelism of the axes of the two face ends of the pin. Since the sleeve 42 near the face end of the pin 41 is mounted on the latter, the sleeve 42 is substantially displaced parallel instead of tilting. This causes a loading of the teeth that is as even as possible.

The intermediate bush 48 forms a replaceable friction bearing for the planet 49. In order to bring about the mounting, oil is fed into the ring slit 52. There, the oil reaches the oil transport bore 57 where is can radially flow to the outside towards the intermediate bush 48. In the oil feed pocket 58 the oil collects and builds up a pressure. Through the second oil transport bore 49 the oil reaches the oil bearing pocket 60.

The planet 49 is thus mounted in a permanently sliding manner on an oil film. This already produces a noise optimisation of a wind power transmission. At the same time, the efficiency compared with conventional versions is increased. Finally, such a friction bearing can be quite easily procured and maintained.

For maintaining the flexpin 40 the locking ring 46 is initially removed. After this, the holding cup 61 can be pulled off axially towards a maintenance side 70 of the flexpin. Following this, the axial bearing ring 62 with the friction bearing 63 in the form of a bronze ring can likewise be axially pulled off the sleeve 42.

The axial bearing ring 62 is preferably releasably connected to the intermediate bush 48 via a screw connection (not shown), but can also be embodied unitarily.

The intermediate bush 48 can thus be pulled off either jointly with the axial bearing ring 62 or following this separately, likewise axially towards the maintenance side 70, maintained or replaced and reinserted again.

The planet 49 remains stationary when the turbine is stationary because it intermeshes between the internal gear 50 and the sun 51. Otherwise, this planet can also be pulled off as soon as at least the axial bearing ring 62 is removed, preferably likewise the holding cup 61 and the intermediate bush 48.

It is to be understood that theoretically the intermediate bush 48 and the second axial bearing ring 64 can also be embodied or connected unitarily. In this case however, this component can only be axially pulled off when initially the planet 49 has been pulled off.

The hydrostatic friction bearing 80 in FIG. 4 is an excellent alternative to a rolling bearing 81 for the main shaft 1. A rolling bearing requires a pre-tension, therefore is subjected to an increased wear. The hydrostatic friction bearing 80 manages without these problems.

In the example provided here two bearing rings 82, 83 are provided. Both bearing rings 82, 83 are in two pieces in circumference, so that they can be radially removed with respect to an axis of rotation 84.

The bearing rings 82, 83 have axial oil pockets 84, 86 at their axial shoulders, directed towards a collar 87 radially protruding from the shaft 1 in between.

Via a screw connection (not shown in more detail) between a housing 88 and the axial bearing rings 82, 83 the main shaft 1 is seated axially fixed. Such a screw connection can for example be effected via a connecting disc ring at two axial face ends 89, 90. The housing 88 can be in the shape of the housing 17 described above.

In addition, radial oil pockets 92, 93 for the radial mounting of the main shaft 1 are provided on the bearing rings 82, 83.

A high-pressure pump is provided, which pumps the oil with approximately 100 bar bearing pressure in the oil pockets 85, 86, 92, 93. This results in an excellent mounting with little oil passage.

What is claimed is:

1.-45. (canceled)

46. A wind power plant comprising a transmission, wherein a torque is transmitted from a hub via a main shaft to the transmission, and wherein the transmission at least in part is arranged within a hollow space in the main shaft, wherein part of the main shaft forms a rotating transmission housing, a shoulder stop being provided for limiting a deformation of the transmission housing with respect to its axis of rotation.

47. The wind power plant of claim 46, wherein the main shaft has a cup shape, and the shoulder stop is provided at an open edge of the main shaft which is constructed to be an access side of the main shaft.

48. The wind power plant of claim 46, wherein the shoulder stop is arranged at least in part within the main shaft, the shoulder stop cantilevering into the main shaft, preferably the shoulder stop being fastened to a stiffening disc which stands perpendicular to the axis of rotation of the main shaft.

49. The wind power plant of claim 46, wherein the main shaft on an open end comprises a stiffening disc ring which stands perpendicular to the axis of rotation of the main shaft, the shoulder stop being arranged between the main shaft and a planet carrier.

50. The wind power plant of claim 46, wherein the shoulder stop in an unloaded state has a spacing of less than 10 cm to the main shaft, preferably of less than 1 cm, particularly preferably less than 1 mm, above all comprises a friction bearing for the main shaft.

51. A flexpin assembly for a wind power plant, comprising a pin and a sleeve mounted on the pin, wherein the sleeve is equipped for the purpose of carrying a planet, wherein the sleeve of the flexpin assembly comprises an intermediate bush for carrying the planet, the intermediate bush being mounted on the sleeve with a loose seat.

52. The flexpin assembly of claim 51, wherein the intermediate bush is designed as friction bearing bush, the intermediate bush preferably comprising bronze on a sliding surface.

53. The flexpin assembly of claim 51, wherein the intermediate bush is free of radial protrusions on a side facing away from the pin, so that it can be axially pulled off via a free pin end.

54. The flexpin assembly of claim 51, wherein the intermediate bush has a disc-shaped axial bearing ring, particularly towards a free end of the pin, above all connected to the intermediate bush or unitarily formed with the latter, preferably the intermediate bush being mirror-symmetrical with respect to a mirror plane perpendicular to the pin.

55. The flexpin assembly of claim 51, wherein the intermediate bush comprises a radial oil transport bore, the intermediate bush preferably comprising an oil feed pocket, which is orientated towards the pin, and the intermediate bush comprising an oil bearing pocket, which is orientated away from the pin and thus radially from the inside towards the planet.

56. The flexpin assembly of claim 51, comprising an axial bearing ring, particularly with a bronze ring, preferably two axial bearing rings for the sliding of the planet and/or of the intermediate bush.

57. A wind power plant, particularly the wind power plant of claim 46, comprising a transmission, wherein the transmission comprises a flexpin assembly including a pin and a sleeve mounted on the pin, wherein the sleeve is equipped for the purpose of carrying a planet, wherein the sleeve of the flexpin assembly comprises an intermediate bush for carrying the planet, the intermediate bush being mounted on the sleeve with a loose seat.

58. The wind power plant of claim 57, comprising a housing and a main shaft mounted therein, wherein the main shaft and the housing comprise a hydrostatic friction bearing against each other, preferably comprising two bearing rings with a collar in between radially protruding from the main shaft.

59. The wind power plant of claim 57, wherein between the bearing rings and the collar, at least one of axial and radial bearing pockets are provided for transporting oil.

60. The wind power plant of claim 58, wherein an axial bearing ring is reasonably fixed on the housing, particularly two axial bearing rings are releasably fixed on the housing.

61. The wind power plant of claim 58, wherein the friction bearing comprises a segmented bearing ring.

62. The wind power plant of claim 58, wherein an oil pump for introducing oil as bearing fluid in bearing pockets is provided, particularly with a pressure of more than 50 bar, preferably with a pressure of over 80 bar, more preferably with a pressure of approximately 100 bar.

63. The wind power plant of claim 62, wherein a pressure drop detection for the oil pressure is provided, which reduces the pump output, but which preferably increases the pump output in order to at least substantially hold the bearing pressure constant when the oil pressure drops as a result of a shaft displacement.

64. The wind power plant of claim 57, wherein a torque is transmitted from a hub via a main shaft to the transmission, and wherein the main shaft is mounted against a housing, characterized in that a controlled fluid damper for the main shaft is provided, wherein the main shaft is mounted on a shoulder stop.

65. The wind power plant of claim 57, wherein a sensor for a deformation is provided on a stiffening disc.

66. The wind power plant of claim 57, wherein a fluid damper is arranged on a friction bearing, the fluid damper preferably comprising several fluid outlets which are arranged distributed over a circumference of the main shaft and can preferably be activated individually.

67. The wind power plant of claim 57, comprising a housing and a main shaft mounted therein, wherein the main shaft and the housing particularly comprise a pre-tensioned cone bearing or a hydrostatic friction bearing against each other, characterized in that a unitary pre-tension adjusting unit is provided.
